(19) United States
(12) Patent Application Publication
(10) Pub. No.: US 2006/0127033 A1
(43) Pub. Date: Jun. 15, 2006

(54) Apparatus for recording and reproducing data and recording method therefor

(75) Inventor: Jin-Whi Kim, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/272,800

(22) Filed: Nov. 15, 2005

(30) Foreign Application Priority Data
Dec. 13, 2004 (KR) 2004-104839

(51) Int. Cl. H04N 5/91

(52) U.S. Cl. 386/46

(57) ABSTRACT

A recording and reproducing apparatus and a recording method for use in the same. The recording and reproducing apparatus allows a user to freely select a desired input terminal from among a plurality of input terminals when video/audio information received from a satellite receiver or a set-top box is transmitted to an input terminal of the recording and reproducing apparatus, such that the user can receive desired information via the selected input terminal. A plurality of input terminals of the recording and reproducing apparatus can be freely selected by a user. The recording method determines a reception time of a satellite signal using a satellite receiver, selects an input terminal of the recording and reproducing apparatus to which the satellite signal is to be transmitted, and records the satellite signal received in the selected input terminal at the determined reception time.

### CROSS-REFERENCE TO RELATED APPLICATION

This application claims the benefit under 35 U.S.C. §119(a) of Korean Patent Application No. 2004-104839, filed on Dec. 13, 2004 in the Korean Intellectual Property Office, the entire disclosure of which is hereby incorporated by reference.

### BACKGROUND OF THE INVENTION

1. Field of the Invention

The present invention relates to an apparatus for recording and reproducing data and a recording method therefor. More particularly, the present invention relates to an apparatus for recording and reproducing data and a recording method, which can select a desired input terminal when recording a signal received from a satellite receiver.

2. Description of the Related Art

Recently, a variety of devices for recording and reproducing audio and video signals have been newly introduced to the consumer market, for example, a Video Cassette Recorder (VCR), a Digital Video Disk Player (DVDP), and a combination-type recording and reproducing apparatus wherein a Hard Disk Drive (HDD) and the DVDP are combined in a common apparatus.

Also, the number of users who view satellite broadcast data by connecting an external-type satellite receiver or an external-type set-top box to a recording and reproducing apparatus has been rapidly increasing. Therefore, the users can freely record data of a desired channel at a desired time by connecting the satellite receiver or the set-top box to the recording and reproducing apparatus.

If the user desires to receive a satellite signal via the satellite receiver or the set-top box and record the received satellite signal using the recording and reproducing apparatus, the user can record the satellite signal using a specific function called a Synchro-record function. The synchro-record function is indicative of a specific operation, during which the satellite receiver or the set-top box is connected to an input terminal of the recording and reproducing apparatus and a signal received from the satellite receiver or the set-top box is received via the input terminal and at the same time is recorded.

In the meantime, the input terminal of the recording and reproducing apparatus is comprised of a first line input terminal, a second line input terminal, and a Radio Frequency (RF) input terminal, and so on. A conventional synchro-record function has been designed to receive a satellite signal via only the first line input terminal.

A method for recording a satellite signal in the recording and reproducing apparatus using the above-mentioned synchro-record function will hereinafter be described with reference to FIG. 1. If a user desires to perform a reserved or scheduled recording function using the synchro-record function, the user establishes a desired time and a corresponding channel in the satellite receiver or the set-top box at step S10. When the current time reaches the user-desired reserved time, the satellite receiver or the set-top box receives a satellite signal associated with the corresponding channel, and transmits the received satellite signal to the first line (line 1) input terminal of the recording and reproducing apparatus.

The recording and reproducing apparatus periodically determines whether an input signal transmitted to the first line input terminal is detected at step S20. If the input signal is detected at step S20, it is determined whether the recording and reproducing apparatus can normally receive a signal via the first line input terminal and can record the received signal at step S30. In other words, it is determined whether the recording and reproducing apparatus is in a recordable state at step S30.

If it is determined that the recording and reproducing apparatus is in the recordable state at step S30, the recording and reproducing apparatus starts recording the received signal at step S40. Then, the recording and reproducing apparatus determines whether the signal is continuously transmitted to the first line input terminal, and continues to perform the recording operation at steps S20 through S40. Otherwise, if there is no signal transmitted to the first line input terminal at step S20, the recording and reproducing apparatus determines whether the recording operation is in progress at step S50. If it is determined that the recording operation is in progress at step S50, the recording and reproducing apparatus determines that the recording operation is completed, such that it terminates the recording operation at step S60.

However, in the case of performing the synchro-record function, the above-mentioned recording and reproducing apparatus has been designed to allow the satellite receiver or the set-top box to be connected to only the first line input terminal, such that it is unable to use other input terminals and a user is also unable to select a desired input terminal from among a plurality of input terminals.

Also, if the user desires to receive any other signal via the first line input terminal, the user must remove a line connected to the satellite receiver or the set-top box from the recording and reproducing apparatus, and must connect other signal input lines to the recording and reproducing apparatus, resulting in even greater inconvenience of the user.

Accordingly, there is a need for an apparatus and device that allows a user to freely select a desired input terminal from among a plurality of input terminals.

### SUMMARY OF THE INVENTION

Therefore, it is an aspect of the invention to provide a recording and reproducing apparatus and a recording method for the same, which allow a user to freely select a desired input terminal from among a plurality of input terminals when video/audio information received from a satellite receiver or a set-top box is transmitted to an input terminal of the recording and reproducing apparatus, such that the user can receive desired information via the selected input terminal.

It is another aspect of the invention to provide a recording and reproducing apparatus and a recording method for the same, which allow a user to freely use one or more input terminals contained in the recording and reproducing apparatus.

Additional aspects and/or advantages of the invention will be set forth in part in the description which follows and, in part, will be obvious from the description, or may be learned by practice of the invention.

In accordance with one aspect of the invention, the above and/or other aspects can be achieved by the provision of a recording method for use in a recording and reproducing apparatus, comprising the steps of selecting one of a plurality of input terminals in order to record an external signal in the recording and reproducing apparatus; and receiving the external signal via the selected input terminal, and recording the received signal.

Preferably, the external signal is indicative of a signal received via a satellite receiver.

Preferably, the input terminal comprises a first line input terminal, a second line input terminal, and a Radio Frequency (RF) input terminal.

Preferably, the recording of the external signal begins when the external signal is received in the selected input terminal, and is terminated when the external signal is not received in the selected input terminal any more.

In accordance with another aspect of the invention, there is provided a recording method for use in a recording and reproducing apparatus, comprising the steps of determining a predetermined time at which a satellite signal is to be received using a satellite receiver; selecting an input terminal of the recording and reproducing apparatus to which the satellite signal is to be transmitted; and recording the satellite signal transmitted to the selected input terminal at the determined time.

Preferably, the recording of the satellite signal comprises the steps of determining whether the satellite signal is transmitted to the input terminal; and setting the selected input terminal to a reception state upon receipt of the satellite signal, and starting a recording operation.

Preferably, the method further comprises the step of terminating the recording of the satellite signal when the satellite signal is not transmitted to the selected input terminal during the recording of the satellite signal.

In accordance with yet another aspect of the invention, there is provided a recording and reproducing apparatus, comprising a plurality of input terminals for receiving an external signal; and a recording unit for recording the received external signal received via a selected input terminal from among the plurality of input terminals.

Preferably, the input terminals comprise a first line-input terminal, a second line input terminal, and a Radio Frequency (RF) input-terminal.

Preferably, the apparatus further comprises a controller for starting the recording of the external signal when the external signal is received in the selected input terminal, and terminating the recording of the external signal when the external signal is not received in the selected input terminal any longer.

In accordance with yet another aspect of the invention, there is provided a recording and reproducing apparatus, comprising a satellite receiver for receiving a satellite signal; one or more input terminals to which the satellite signal received in the satellite receiver is to be transmitted; and a controller for allowing the satellite signal to be transmitted to a selected input terminal from among the input terminals.

Preferably, the apparatus further comprises a recording unit for starting a recording operation when the satellite signal is received in the selected input terminal, and terminating the recording operation when the satellite signal is not received in the selected input terminal any more.

Preferably, the satellite receiver receives the satellite signal only during a specific time determined to be a reception time of the satellite signal, and transmits the received satellite signal to the selected input terminal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart illustrating a recording method for use in a recording and reproducing apparatus using a conventional synchro-record function;

FIG. 2 is a block diagram illustrating a recording system for use in a recording and reproducing apparatus in accordance with an embodiment of the present invention;

FIG. 3 is a block diagram illustrating a plurality of components for use in the recording :and reproducing apparatus shown in FIG. 2 in accordance with an embodiment of the present invention;

FIG. 4 is an exemplary view illustrating a display image for selecting an input terminal in the recording and reproducing apparatus shown in FIG. 3 in accordance with an embodiment of the present invention; and

FIGS. 5A and 5B are flow charts illustrating a recording method using a synchro-record function of the recording and reproducing apparatus shown in FIG. 2 in accordance with an embodiment of the present invention.

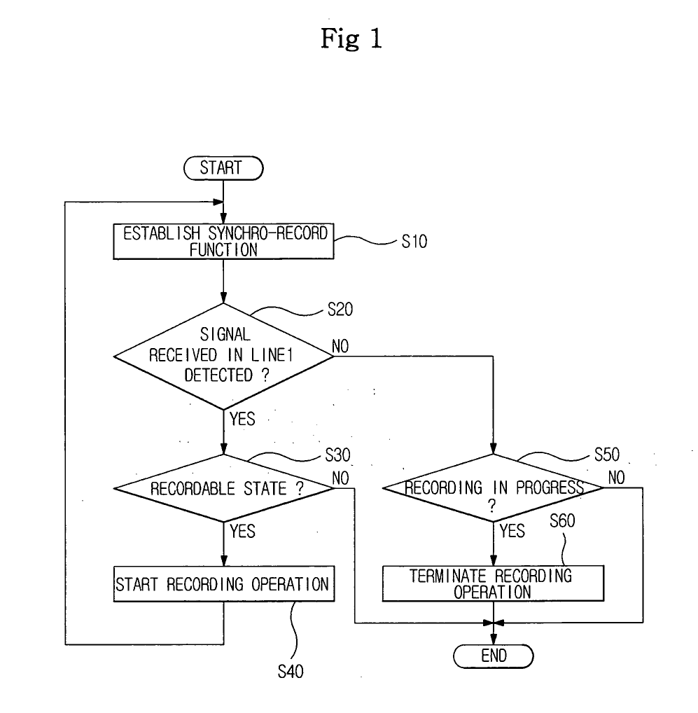

Throughout the drawings, like reference numbers will be understood to refer to like elements, features and structures.

### DETAILED DESCRIPTION OF EXEMPLARY EMBODIMENTS

Reference will now be made in detail to exemplary embodiments of the present invention described in combination with the attached drawings

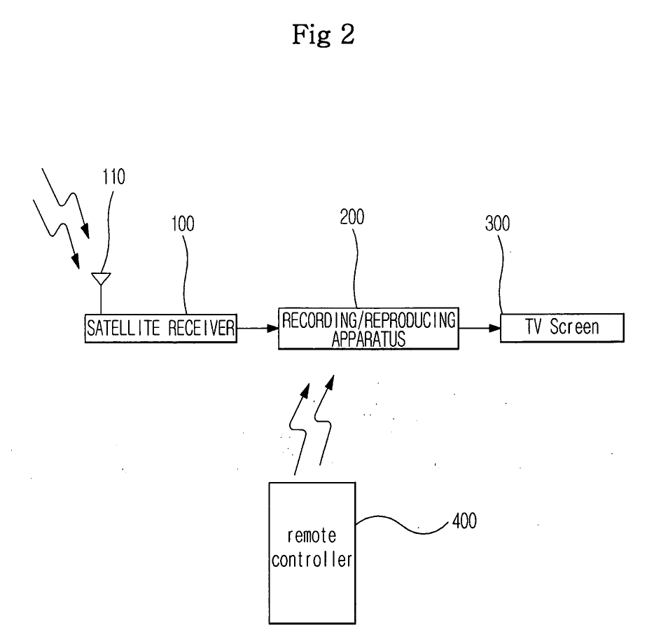

FIG. 2 is a block diagram illustrating a recording system for use in a recording and reproducing apparatus in accordance with a preferred embodiment of the present invention. As shown in FIG. 2, the recording and reproducing apparatus 200 is connected to a satellite receiver 100 via a transmission cable, and is also connected to a TV screen 300 acting as a display device. The recording and reproducing apparatus 200 receives a variety of control signals from a remote controller 400 acting as an external input device, such that it can properly respond to the received control signals.

The satellite receiver 100 is needed to receive cable or satellite broadcast data, and can be implemented as a set-top box (STB). Generally, the set-top box (STB) amplifies a video signal received from an antenna 110 or removes noise from the received video signal and transmits a corresponding video signal. of a user-desired channel to a TV, such that a user must, install a proper STB according to a broadcast scheme of the TV, in other words, an analog broadcast scheme or a digital broadcast scheme.

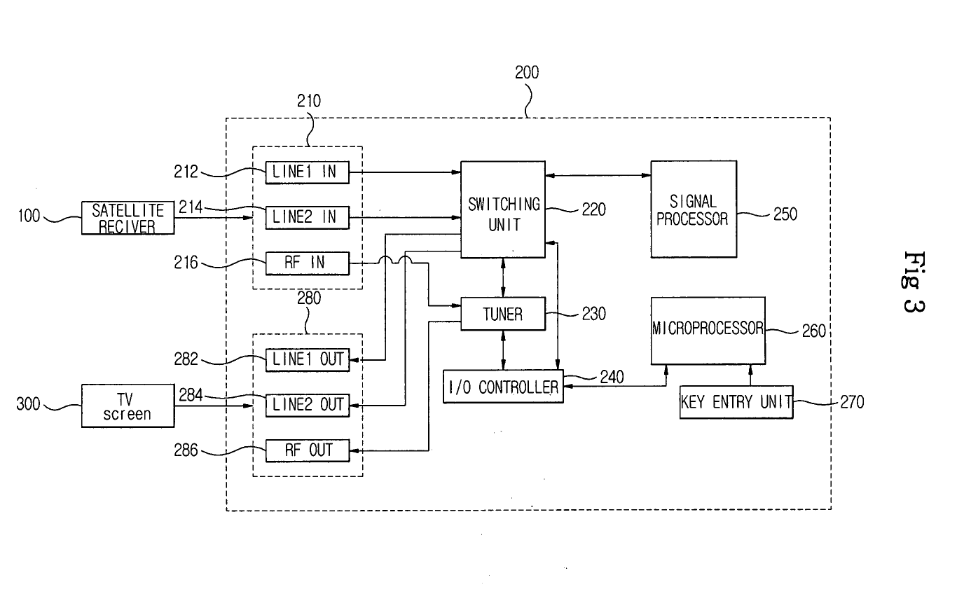

The recording and reproducing apparatus 200 will hereinafter be described in more detail with reference to FIG. 3. The recording and reproducing apparatus 200 comprises an input terminal unit 210, a switching unit 220, a tuner 230, an Input/Output (I/O) controller 240, a signal processor 250, a microprocessor 260, a key entry unit 270, and an output terminal unit 280.

The recording and reproducing apparatus 200 can record and reproduce a file composed of audio and video signals, and is indicative of a VCR, a DVDP, a VCR/DVDP combination system, or a HDD/DVDP combination system, or the like.

The input terminal unit 210 receives a variety of video signals from the satellite receiver 100, and comprises a first line input terminal (LINE1 IN) 212, a second line input terminal (LINE2 IN) 214, and an RF input terminal (RF IN) 216.

The RF input terminal 216 is indicative of a terminal for receiving an airwave broadcast signal, and is generally connected to an antenna. However, according to an embodiment of the present invention, the RF input terminal 216 is connected to an RF signal output line of the satellite receiver 100 (not shown), and can receive data from the third and fourth channels (typically, CHANNELS 3 and 4).

The first and second line input terminals 212 and 214 receive an analog signal in which a brightness signal Y and a chrominance signal C are mixed with one another. In more detail, the first line input terminal 212 is preferably located at the rear of the recording and reproducing apparatus 200, and the second line input terminal 214 is preferably located at the front of the recording and reproducing apparatus 200.

The switching unit 220 is controlled by the I/O controller 240, and is selectively connected to individual terminals of the input terminal unit 210 and the output terminal unit 280, both of which are also connected to the switching unit 220.

The tuner 230 allows a broadcast signal-of a channel requested by the I/O controller 240 to receive the :RF input terminal 216.

The I/O controller 240 receives a control signal from the microprocessor 260, and controls the switching unit 220 and the tuner 230 using the received control signal.

The signal processor 250 receives audio and video signals, converts and decodes the received audio and video signals into digital audio and video signals, stores the resultant audio and video signals in a storage unit (not shown), converts data stored in the storage unit into a specific signal capable of outputting the stored data to a TV screen 300, and outputs the specific signal to the switching unit 220.

The microprocessor 260 is indicative of an Integrated Circuit (IC) in the form of a single chip in which a Central Processing Unit (CPU) (not shown) and, preferably, an MPEG decoder (not shown) for decoding a signal compressed by an MPEG scheme are combined with each other, and is adapted to control the overall system of the recording and reproducing apparatus 200.

The key entry unit 270 comprises a plurality of number keys, a plurality of arrow keys, and a plurality of function keys, such that it can transmit signals for establishing or controlling functions supported by the recording and reproducing apparatus 200 to the microprocessor 260 using the above-mentioned keys. The key entry unit 270 is contained in a main body of the recording and reproducing apparatus 200. In the meantime, a remote controller 400 (shown in FIG. 2) can also transmit the above-mentioned signals for establishing or controlling the functions supported by the recording and reproducing apparatus 200 to the microprocessor 260.

The output terminal unit 280 outputs a received signal or a signal stored in the storage unit (not shown) to the TV screen 300, and comprises a first line output terminal (LINE1 OUT) 282, a second line output terminal (LINE2 OUT) 284, and an RF output terminal (RF OUT) 286.

The RF output terminal 286 transmits a broadcast signal selected by the tuner 230 out of the recording and reproducing apparatus 200.

The first and second line output terminals 282 and 284 are indicative of terminals capable of transmitting an analog signal in which a brightness signal Y and a chrominance signal C are mixed to the TV screen 300.

In accordance with an embodiment of the present invention, a user can select broadcast data of a desired channel through the use of the satellite receiver 100 such that the user can view the selected broadcast data. If the user desires to view a predetermined program to be broadcast during a specific time zone, the user can directly view the program during the specific time zone or can command the recording and reproducing apparatus 200 to record the program. In this case, in order to command the recording and reproducing apparatus 200 to record the program, the user commands the recording and reproducing apparatus 200 to perform a reserved recording function using the synchro-record function. Also, if the user desires to view the broadcast program at a later time after recording the broadcast program because the user must go out during the specific time zone, the above-mentioned synchro-record function enables the recording and reproducing apparatus 200 to perform the reserved recording function.

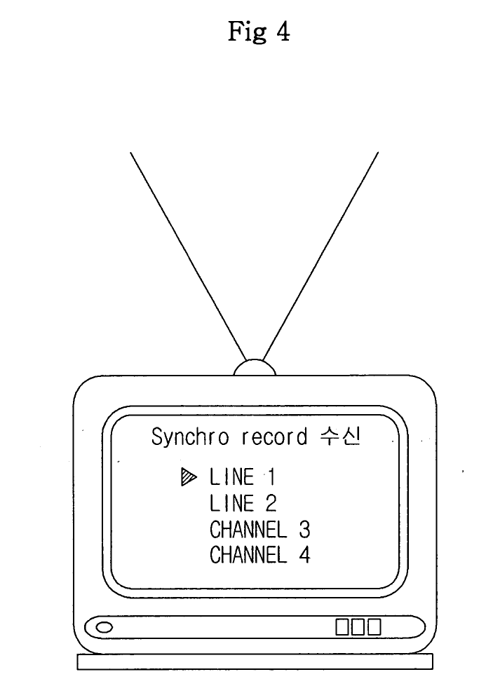

In order to record desired data in the recording and reproducing apparatus 200 using the synchro-record function, a signal output terminal (not shown) of the satellite receiver 100 and the input terminal unit 210 of the recording and reproducing apparatus 200 must be connected to each other via a transmission cable. In this case, the user can select a desired input terminal from among a plurality of input terminals 212, 214, and 216 contained in the input terminal unit 210. Needless to say, the user must connect the selected input terminal to the signal output terminal (not shown) of the satellite receiver 100 using the transmission cable. An input terminal selection image (shown in FIG. 4) of the recording and reproducing apparatus 200 is displayed on the TV screen 300. In this case, if the user selects a desired input terminal, such as an input terminal connected via a transmission cable, from among the first line input terminal 212, the second line input terminal 214, and the RF In (channels 3 and 4) 216, the microprocessor 260 controls a variety of devices in the recording and reproducing apparatus 200 so as to process signals received via the selected input terminal.

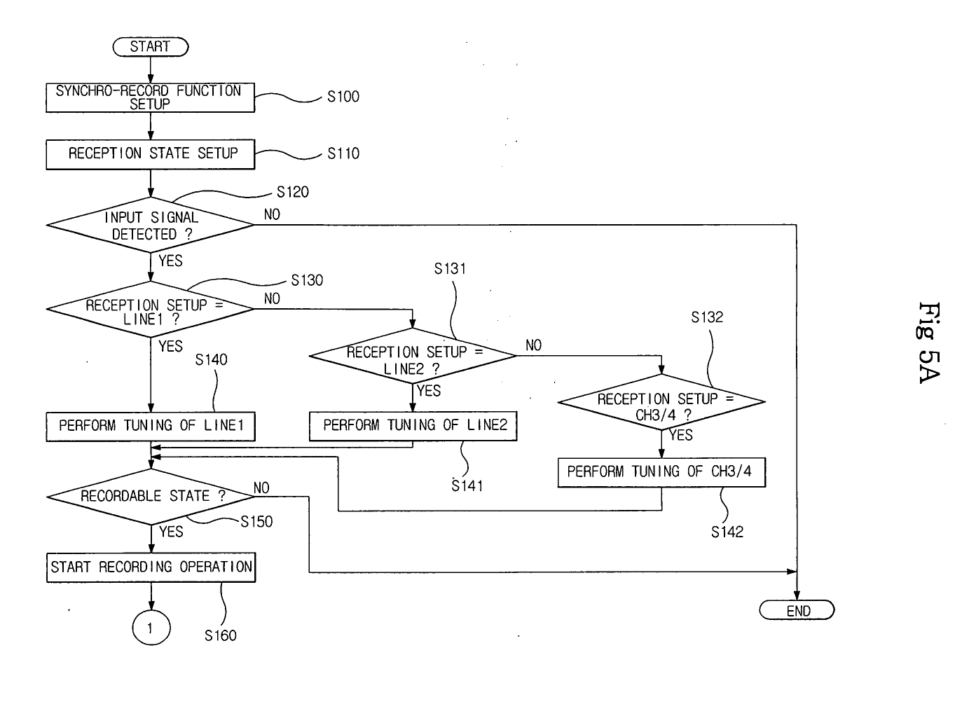

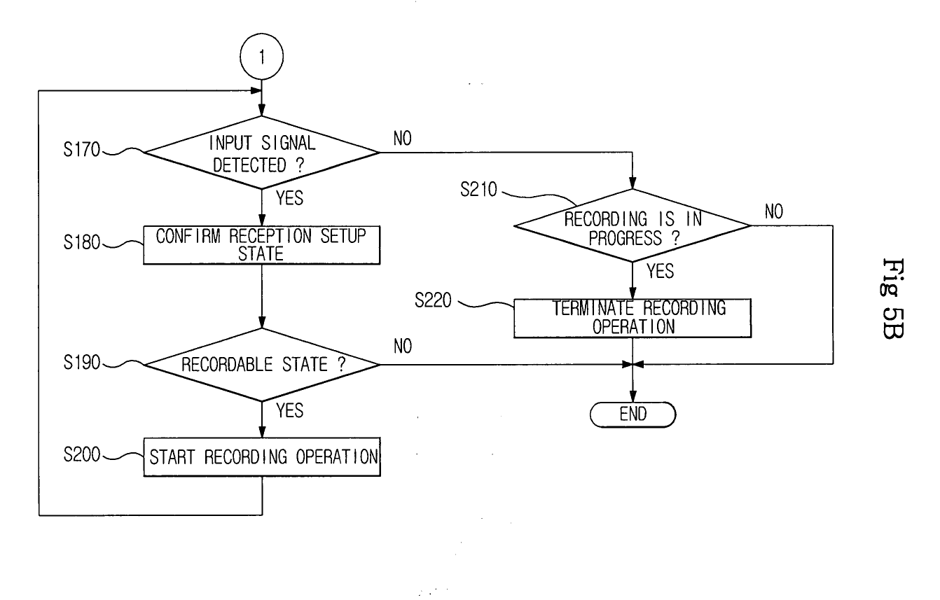

FIGS. 5A and 5B are flow charts illustrating a recording method using a synchro-record function of the recording and reproducing apparatus shown in FIG. 2 in accordance with the present invention.

Referring to FIGS. 5A and 5B, a user enters channel and time information of a desired satellite broadcast program to be recorded in the satellite receiver 100. The user preferably establishes the synchro-record function in the recording and reproducing apparatus 200 using the key entry unit 270 or the remote-controller 400 at step S100.

If the synchro-record function is selected, the recording and reproducing apparatus 200 displays an image for selecting an input terminal to which a signal is received from the satellite receiver 100 on the TV screen 300. The user connects a desired input terminal from among a plurality of input terminals 212, 214, and 216 to the satellite receiver 100 using the transmission cable. If the user selects a desired input terminal on the TV screen 300, the microprocessor 260 memorizes information associated with the input terminal selected by the user at step S110.

If a current time reaches a user-selected time, the satellite receiver 100 periodically determines whether there is an input signal received via the antenna 110. If the satellite receiver 100 receives a signal corresponding to a user-selected channel, it transmits the received signal to the input terminal unit 210 of the recording and reproducing apparatus 200 via the transmission cable at step S120.

The recording and reproducing apparatus 200 determines whether an input terminal selected by the user is indicative of the first line input terminal 212, the second line input terminal 214, or the RF input terminal (channels 3/4) 216 at steps S130, S131, and S132, respectively. Based on the determined result, the recording and reproducing apparatus 200 performs a tuning operation to enable the determined input terminal to receive a signal at steps S140, S141, and S142, respectively. For example, if the user selects the first line input terminal 212 to receive the signal, the microprocessor 260 transmits a signal indicative of the selection of the first line input terminal 212 to the I/O controller 240. The I/O controller 240 controls the switching unit 220 based on the received signal, such that it controls the first line input terminal 212 to receive the signal. If the user selects the RF input terminal 216 to receive the signal, the microprocessor 260 transmits a signal indicative of the selection of the RF input terminal 216 to the I/O controller 240. The I/O controller 240 controls the tuner 230 based on the received signal, such that it controls the RF input terminal 216 to receive a signal of a third or fourth channel (CHANNEL 3 or CHANNEL 4).

If the tuning operation for the selected input terminal is completed, the microprocessor 260 receives a signal via the selected input terminal, and determines whether a current state is a recordable state at step S150. In more detail, the microprocessor 260 determines whether the input terminal selected by the user on the input terminal selection image displayed on the TV screen is equal to a terminal actually connected via a transmission cable, and determines whether the signal can be normally received based on the determined result.

If it is determined that the current state is the recordable state, the microprocessor 260 receives a signal transmitted to the selected input terminal from the satellite receiver 100. The received signal is transmitted to the signal processor 250 via the switching unit 220 and the tuner 230, the signal processor 250 processes the received signal based on the recordable state, and the processed result is stored in the storage unit (not shown) at step S160.

If a recording operation begins, the satellite receiver 100 periodically receives a signal during the user-selected time. If there is an input signal, the satellite receiver 100 transmits a received signal to an input terminal connected to the recording and reproducing apparatus 200 at step S170. The microprocessor 260 of the recording and reproducing apparatus 200 confirms that an input terminal set to a reception terminal from among a plurality of input terminals 212, 214, and 216 (S180), receives a signal via the input terminal set to the reception terminal (S190, determines whether a current state is equal to a recordable state, and performs the recording operation according to the determined result at step, S200. The microprocessor 260 repeatedly performs the above-mentioned steps S180, S190, and S200.

If the user-selected time elapses, the antenna 110 does not receive the signal associated with the selected channel any longer. The satellite receiver 100 determines the absence of the input signal, and does not transmit a signal to the recording and reproducing apparatus 200 at step S170. If the signal is not received in the input terminal any more, the recording and reproducing apparatus 200 determines whether the recording operation is in progress at step S210. If it is determined that the recording operation is in progress in the recording and reproducing apparatus 200 at step S210, the microprocessor 260 determines that the recording operation is completed, and terminates the recording operation at step S220.

In other words, if an input signal is transmitted from the satellite receiver 100 to the input terminal unit 210, the microprocessor 260 begins the recording operation. If a signal input operation is interrupted, the microprocessor 260 terminates the recording operation, such that it can record satellite broadcast data received from the satellite receiver 100. In this case, the input terminal unit 210 of the recording and reproducing apparatus 200, which is capable of receiving the output signal of the satellite receiver 100, can be freely selected by the user.

As is apparent from the above description, in the case of transmitting video and audio signals received in the satellite receiver to the recording and reproducing apparatus according to an embodiment of the present invention, the recording and reproducing apparatus can receive the video and audio signals via a user-desired input terminal from among a plurality of input terminals.

Although a first line input terminal is connected to other appliances, the recording and reproducing apparatus receives a satellite signal via other unused input terminals such that it can record the received satellite signal.

Although exemplary embodiments of the present invention have been shown and described, it would be appreciated by those skilled in the art that changes or modifications may be made in these embodiments without departing from the principles and spirit of the invention, the scope of which is defined in the claims and their equivalents.

What is claimed is:

1. A recording method for use in a recording and reproducing apparatus, comprising the steps of:
selecting one of a plurality of input terminals in order to record an external signal in the recording and reproducing apparatus; and
receiving the external signal via the selected input terminal, and recording the received signal.

2. The method according to claim 1, wherein the external signal is indicative of a signal received via a satellite receiver.

3. The method according to claim 1, wherein the input terminal comprises a first line input terminal, a second line input terminal, and a Radio Frequency (RF) input terminal.

4. The method according to claim 1, wherein the step of recording of the external signal begins when the external signal is received in the selected input terminal, and is terminated when the external signal is not received in the selected input terminal any longer.

5. A recording method for use in a recording and reproducing apparatus, comprising the steps of:
determining a predetermined time at which a satellite signal is to be received using a satellite receiver;
selecting an input terminal of the recording and reproducing apparatus to which the satellite signal is to be transmitted; and
recording the satellite signal transmitted to the selected input terminal at the determined time.

6. The method according to claim 5, wherein the step of recording of the satellite signal further comprises the steps of:
determining whether the satellite signal is transmitted to the selected input terminal; and
setting the selected input terminal to a reception state upon receipt of the satellite signal, and starting a recording operation.

7. The method according to claim 5, further comprising the step of:
terminating the recording of the satellite signal when the satellite signal is not transmitted to the selected input terminal during the recording of the satellite signal.

8. A recording and reproducing apparatus, comprising:
a plurality of input terminals for receiving an external signal; and
a recording unit for recording the received external signal received via a selected input terminal from among the plurality of input terminals.

9. The apparatus according to claim 8, wherein the input terminals comprise a first line input terminal, a second line input terminal, and a Radio Frequency (RF) input terminal.

10. The apparatus according to claim 8, further comprising:
a controller for starting the recording of the external signal when the external signal is received in the selected input terminal, and terminating the recording of the external signal when the external signal is not received in the selected input terminal any longer.

11. A recording and reproducing apparatus, comprising:
a satellite receiver for receiving a satellite signal;
one or more input terminals to which the satellite signal received in the satellite receiver is to be transmitted; and
a controller for allowing the satellite signal to be transmitted to a selected input terminal from among the input terminals.

12. The apparatus according to claim 11, further comprising:
a recording unit for starting a recording operation when the satellite signal is received in the selected input terminal, and terminating the recording operation when the satellite signal is not received in the selected input terminal any longer.

13. The apparatus according to claim 11, wherein the satellite receiver receives the satellite signal only during a specific time determined to be a reception time of the satellite signal, and transmits the received satellite signal to the selected input terminal.

14. A recording and reproducing apparatus, comprising:
a plurality of input terminals for receiving an external signal;
a recording unit for recording the received external signal received via a selected input terminal from among the plurality of input terminals; and
a controller for starting the recording of the external signal when the external signal is received in the selected input terminal, and terminating the recording of the external signal when the external signal is not received in the selected input terminal any more.

15. A recording method for use in a recording and reproducing apparatus, comprising the steps of:
selecting one of a plurality of input terminals in order to record an external signal in the recording and reproducing apparatus; and
receiving the external signal via the selected input terminal, and recording the received signal, wherein recording of the external signal begins when the external signal is received in the selected input terminal, and is terminated when the external signal is not received in the selected input terminal any longer.
